(19) United States
(12) Patent Application Publication
(10) Pub. No.: US 2021/0333943 A1
(43) Pub. Date: Oct. 28, 2021

(54) TOUCH SUBSTRATE AND MANUFACTURING METHOD THEREOF, TOUCH DISPLAY PANEL AND TOUCH DISPLAY APPARATUS

(71) Applicant: BOE TECHNOLOGY GROUP CO., LTD., Beijing (CN)

(72) Inventors: Yuanyuan Li, Beijing (CN); Meizhu Zheng, Beijing (CN)

(73) Assignee: BOE TECHNOLOGY GROUP CO., LTD., Beijing (CN)

(21) Appl. No.: 16/613,167

(22) PCT Filed: May 13, 2019
(86) PCT No.: PCT/CN2019/086632

§ 371 Date: Nov. 13, 2019

(30) Foreign Application Priority Data
Jun. 28, 2018 (CN) 201810689677.9

(51) Int. Cl. G06F 3/044; G06F 3/041

(52) U.S. Cl. CPC G06F 3/0446; G06F 2203/04103; G06F 2203/04111; G06F 3/0412

(57) ABSTRACT

A touch substrate includes a plurality of first electrodes extending in a first direction, a plurality of second electrodes (20) extending in a second direction, and a plurality of dummy electrodes (30). The second direction crosses the first direction. Each of the plurality of first electrodes may include a plurality of first electrode blocks (11). Each of the plurality of second electrodes (20) may include a plurality of second electrode blocks (21). The plurality of dummy electrodes (30) is spaced apart from one another and between opposite sides of at least one pair of a first electrode block (11) and an adjacent second electrode block (21).

### CROSS-REFERENCE TO RELATED APPLICATIONS

This application claims benefit of the filing date of Chinese Patent Application No. 201810689677.9 filed on Jun. 28, 2018, the disclosure of which is hereby incorporated in its entirety by reference.

### TECHNICAL FIELD

The present disclosure relates to display technology, and more particularly, to a touch substrate and a manufacturing method thereof, a touch display panel, and a touch display apparatus.

### BACKGROUND

A touch substrate is generally used in combination with a display substrate. The present mutual-capacitive touch substrate is provided with a plurality of touch driving electrodes and a plurality of touch sensing electrodes.

As a form of the touch substrate, the touch driving electrodes and the touch sensing electrodes may be grid electrodes arranged in the same layer and spaced apart from one another. An electrode can be a bridge at the junction of the two electrodes. The touch function may be realized by capacitive sensing between adjacent sides of the touch driving electrode and touch sensing electrode.

The spacing between the adjacent sides of the touch driving electrode and the touch sensing electrode should be a certain size based on the requirement of touch precision, sensing intensity, etc. The light transmittance of the area having the touch drive electrode or the touch sensing electrode is different from the light transmittance of the area without them such as the interval space between the two electrodes, thereby causing the user to see a very shallow grid-like texture. In order to prevent the entire touch substrate from generating a substantially grid-like texture as a whole, an electrically floating dummy electrode is usually disposed in the same layer between the adjacent touch sensing electrode and touch driving electrode. The touch sensitivity of such touch substrate needs to be improved.

### BRIEF SUMMARY

One example of the present disclosure provides a touch substrate. The touch substrate may include a plurality of first electrodes extending in a first direction, each of the plurality of first electrodes comprising a plurality of first electrode blocks, a plurality of second electrodes extending in a second direction, each of the plurality of second electrodes comprising a plurality of second electrode blocks, the second direction crossing the first direction, and a plurality of dummy electrodes spaced apart from one another between opposite sides of at least one pair of a first electrode block and an adjacent second electrode block.

Optionally, the first electrode blocks, the second electrode blocks, and the dummy electrodes are disposed in a same layer.

Optionally, adjacent first electrode blocks of a same first electrode are connected by a bridge insulated from the second electrodes.

Optionally, the bridge is above or below a layer where the plurality of second electrodes is located.

Optionally, every adjacent first electrode blocks of each of the first electrodes is separated by the second electrode blocks.

Optionally, the plurality of dummy electrodes that are not electrically connected to one another are distributed in a direction perpendicular to the opposite sides of at least one pair of the first electrode block and the adjacent second electrode block.

Optionally, the plurality of dummy electrodes that are not electrically connected to one another are distributed in a direction parallel to the opposite sides of at least one pair of the first electrode block and the adjacent second electrode block.

Optionally, the plurality of dummy electrodes that are not electrically connected to one another has the same shape and size.

Optionally, the first electrode blocks, the second electrode blocks, and the dummy electrodes are all grid electrodes.

Optionally, each of the grid electrodes comprises a plurality of grid lines, and the plurality of grid lines forms a plurality of hexagons or a plurality of parallelograms.

Optionally, the plurality of second electrode blocks is directly connected.

Optionally, one of the plurality of first electrodes and the plurality of second electrodes is touch sensing electrodes and the other one of the plurality of first electrodes and the plurality of second electrodes is touch driving electrodes.

One example of the present disclosure is a touch display panel. The touch display panel may include the touch substrate according to one embodiment of the present disclosure; and a plurality of sub-pixels.

Optionally, the touch display panel further comprises a display substrate, the plurality of sub-pixels being disposed on the display substrate, wherein the touch substrate is disposed on a light-emitting side of the display substrate.

Optionally, the first electrode blocks, the second electrode blocks, and the dummy electrodes are all grid electrodes comprising a plurality of grid lines; and the plurality of grid lines are located in spaces among the plurality of sub-pixels.

Optionally, each of the plurality of sub-pixels comprises an OLED light emitting component.

One example of the present disclosure is a touch display apparatus, comprising the touch display panel according to one embodiment of the present disclosure.

One example of the present disclosure is a method of forming a touch substrate, comprising forming a plurality of first electrodes extending in a first direction, each of the plurality of first electrodes comprising a plurality of first electrode blocks; a plurality of second electrodes extending in a second direction, each of the plurality of second electrodes comprising a plurality of second electrode blocks; a plurality of dummy electrodes that are spaced apart from one another between opposite sides of at least one pair of a first electrode block and an adjacent second electrode block.

Optionally, the first electrode blocks, the second electrode blocks, and the dummy electrode are disposed in a same layer.

Optionally, the method further comprises forming a plurality of bridges, wherein each of the plurality of bridges connects adjacent first electrode blocks of a same first electrode, and the plurality of bridges is above or below the layer where the plurality of second electrodes is located.

### BRIEF DESCRIPTION OF THE DRAWINGS

The above and other features and advantages of the present disclosure will become more apparent from the detailed description of exemplary embodiments. It is apparent that the drawings in the following description are only some of the embodiments of the present disclosure, and other drawings may be obtained from those skilled in the art without departing from the drawings. In the drawings:

FIG. 1 is a schematic structural view of a touch substrate according to one embodiment of the present disclosure;

FIG. 2 is a schematic structural view of a touch substrate according to one embodiment of the present disclosure;

FIG. 3 is a schematic structural view of a touch substrate according to one embodiment of the present disclosure;

FIG. 4 is a schematic structural diagram of a touch display panel according to one embodiment of the present disclosure.

### DETAILED DESCRIPTION

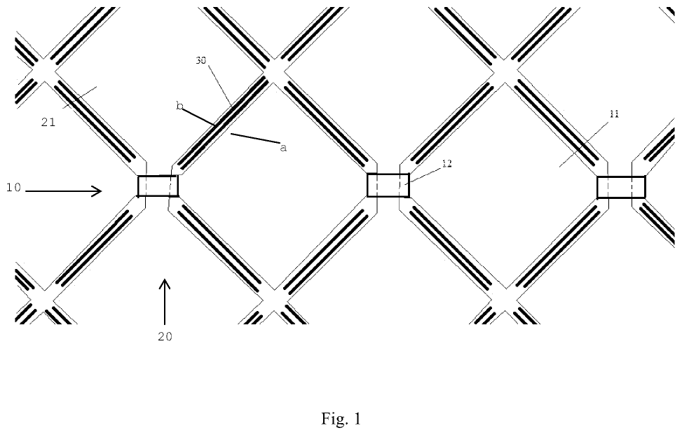

The specific embodiments of the present disclosure are further described in detail below with reference to the drawings and embodiments. The following examples are intended to illustrate the disclosure but are not intended to limit the scope of the disclosure. It should be noted that, in the case of no conflict, the features in the embodiments and the embodiments in the present application could be arbitrarily combined with each other. Throughout the description of the disclosure, reference is made to FIGS. 1-4. When referring to the figures, like structures and elements shown throughout are indicated with like reference numerals. It should be understood that the dimensions of the various parts shown in the drawings are not drawn in the actual scale.

In the present disclosure, the two structures “disposed in the same layer” mean that the two structures are formed by a same layer of material, so they are in the same layer in the laminated relationship. However, this does not mean that the distances between each of the two structures to the substrate are equal, nor does this mean that other layers between each of the two structures and the substrate are identical.

In the present disclosure, the “patterning process” refers to a process of forming a structure having a specific pattern. The “patterning process” may include a photolithography process including one or more steps of forming a material layer, coating a photoresist, exposing, developing, etching, and striping the photoresist etc. Of course, the “patterning process” may also be other processes such as an imprint process, an inkjet printing process, and the like.

### Embodiment 1

The embodiment provides a touch substrate including a plurality of first electrodes 10 extending in a first direction and a plurality of second electrodes 20 extending in a second direction. The second direction crosses the first direction. Each of the first electrodes includes a plurality of first electrode blocks 11. Each of the second electrodes includes a plurality of second electrode blocks 21. The plurality of first electrode blocks 11 are separated by the plurality of second electrode blocks 21. The adjacent first electrode blocks 11 of the same first electrode are connected by a bridge 12 insulated from the second electrodes 20. The adjacent second electrode blocks 21 are connected to form a unitary structure of the second electrode.

The first electrode block 11 and the adjacent second electrode block 21 have opposite sides. The touch substrate further includes at least one dummy electrode 30 disposed between opposite sides of the first electrode block 11 and the adjacent second electrode block. A plurality of dummy electrodes 30 that are not electrically connected to one another are disposed between opposite sides of at least one pair of the first electrode block 11 and the adjacent second electrode block 21. The first electrode blocks 11, the second electrode blocks 20, and the dummy electrodes 30 are disposed in the same layer.

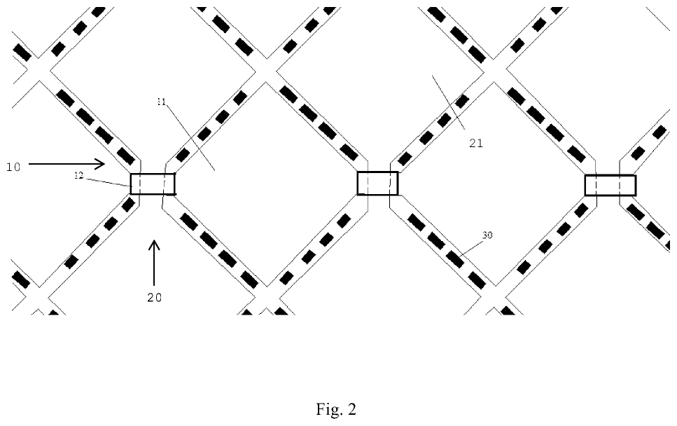

As shown in FIGS. 1 and 2, the first electrode blocks 11 of the same row in a first direction are connected by a bridge 12 into a first electrode, and each of the second electrodes 20 including a plurality of second electrode blocks is of a unitary structure extending in a second direction. A sensing capacitor is formed between opposite sides a and b of the first electrode block 11 and of the adjacent second electrode block 21 respectively. The first electrode block 11 and the adjacent second electrode block 21 are equivalent to two electrodes of a sensing capacitor, respectively. When a user touches, sensing capacitance changes to detect the touch position. In one embodiment of the present supplication, a plurality of dummy electrodes 30 that are not electrically connected to one another are disposed between the opposite sides of the first electrode block 11 and the adjacent second electrode block 21. This is equivalent to forming more electrode pads between the opposite sides of the first electrode block 11 and the second electrode block 21. These electrode pads turn one original sensing capacitor into a plurality of sensing capacitors. The plurality of sensing capacitors may be arranged in a series relationship, in a parallel relationship, or in a series-parallel relationship. The presence of the plurality of dummy electrodes is equivalent to reducing the distance between the original electrode pads, changing strength of the local electric field, and causing redistribution of electric charge, so that more areas can respond sensitively to the user's touch. As a result, the touch area is increased. Furthermore, the sensitivity of the touch is also increased because more sensing areas can sensitively detect the user's touch behavior. Based on the above principle, the more dummy electrodes 30 between the opposite sides of the first electrode block 11 and the adjacent second electrode block 21 (of course, the smaller each dummy electrode 30 is), the higher the sensitivity of the touch.

Optionally, as shown in FIG. 1, between the opposite sides of at least one pair of the first electrode block 11 and the adjacent second electrode block 21, the dummy electrodes 30 which are not electrically connected to one another are distributed in a direction perpendicular to the corresponding opposite sides a and b.

In the embodiment shown in FIG. 1, three sensing capacitors connected in series are actually formed between opposite sides of the first electrode block 11 and the adjacent second electrode block 21, and these three sensing capacitors can sense the user's touch behavior. That is, a first capacitor is formed between side a of the first electrode block and one of the dummy electrodes 30 adjacent to the side a of the first electrode block. A second capacitor is formed between the two dummy electrodes between side a and side b. A third capacitor is formed between side be of the second electrode block and one of the dummy electrodes 30 adjacent to the side b of the second electrode block.

Optionally, as shown in FIG. 2, between the opposite sides of the at least one pair of the first electrode block 11 and the adjacent second electrode block 21, the dummy electrodes 30 which are not electrically connected to one another are distributed in a direction parallel to the corresponding opposite sides.

In the embodiment shown in FIG. 2, the four dummy electrodes 30 between the opposite sides of the first electrode block 11 and the adjacent second electrode block 21 actually correspond to addition of a plurality of electrode pads arranged side-by-side between the two original capacitor electrodes, thereby increasing sensing area and touch sensitivity.

Based on the same principle, those skilled in the art can also design different arrangement manners of the plurality of dummy electrodes 30 between the opposite sides of the first electrode block 11 and the adjacent second electrode block 21, which can increase the sensing area and the touch sensitivity.

Alternatively, between the opposite sides of the at least one pair of the first electrode block 11 and the adjacent second electrode block 21, the dummy electrodes 30 that are not electrically connected to one another have the same shape and size. Therefore, the distribution of the sensing capacitance between the dummy electrodes 30 is more uniform, which is advantageous for simplifying calculation complexity of a touch chip connected to the touch substrate.

Of course, those skilled in the art can also design the dummy electrodes 30 that are not electrically connected to one another between the opposite sides of the first electrode block 11 and the adjacent second electrode block 21 to have different shapes and set their sizes to different values.

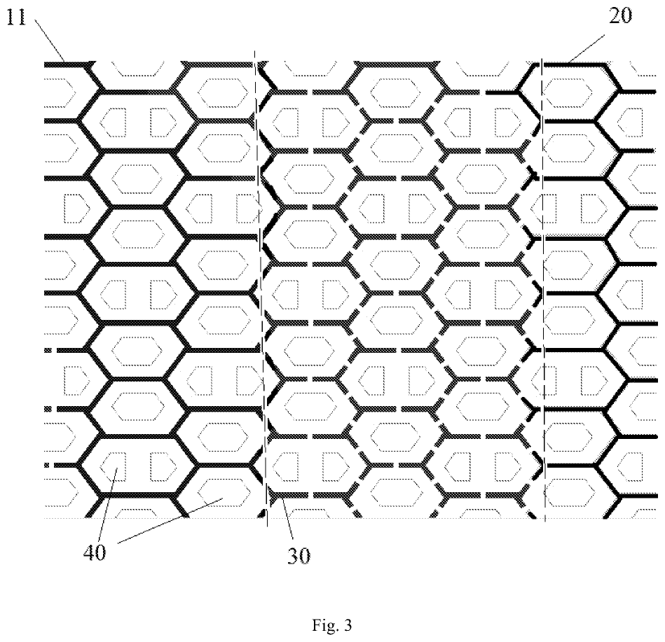

Optionally, as shown in FIG. 3, the first electrode block 11, the second electrode block 21, and the dummy electrode 30 are all grid electrodes. For example, a grid electrode of such a specification can be realized by a patterning process. Also shown in FIG. 3 are sub-pixels 40 in a display substrate that may be bonded with the touch substrate. The sub-pixel 40 of the present disclosure is specifically referred to as the smallest component area capable of emitting a single color. A sub-pixel 40 may be a complete component area that emits a single color such as a red, green, or blue color. Of course, a plurality of smaller component areas may also be used to constitute one sub-pixel 40.

Of course, it should be understood that a “grid electrode” means that the specific structure constituting the grid electrode is a large number of grid lines. However, at this time, the shape of the “electrode” is still the overall boundary of its outermost grid lines (as the dotted lines in FIG. 3). Thus, there are still “opposing sides” between adjacent electrodes.

Meanwhile, the specific form of the grid lines in the electrodes is also diverse. For example, it may be composed of a plurality of hexagons as shown in FIG. 3, or may be composed of a plurality of parallelograms.

Optionally, the first electrode is a touch driving electrode (Tx), and the second electrode 20 is a touch sensing electrode (Rx). Optionally, the first electrode is a touch sensing electrode, and the second electrode 20 is a touch driving electrode.

### Example 2

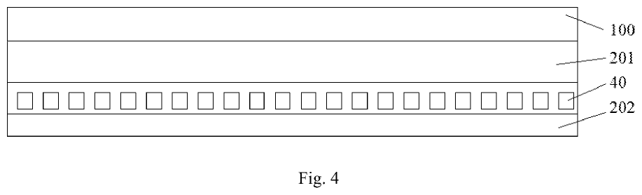

As shown in FIG. 3 and FIG. 4, the touch display panel includes a touch substrate 100 and a plurality of sub-pixels 40. The touch substrate 100 is the touch substrate provided according to one embodiment of the present disclosure.

The touch substrate provided according to one embodiment of the present disclosure is applied to the touch display panel. The touch substrate may be a separate touch substrate combined with the display substrate by means of bonding or the like (for example, in the form of Oncell), or may be integrated with the display substrate (for example, in the form of Incell). Each sub-pixel 40 acts as the smallest component area that emits light of one color.

The sensitivity of the touch performance of the touch display panel is also improved due to the increase of the touch sensing area.

Optionally, as shown in FIG. 4, the touch display panel further includes a display substrate including, for example, a thin film encapsulation layer 201, a substrate 202, and a plurality of sub-pixels 40 disposed between the thin film encapsulation layer 201 and the substrate 202. The sub-pixels 40 are disposed on the display substrate, and the touch substrate 100 is disposed on the light-emitting side of the display substrate.

Optionally, as shown in FIG. 3, when the first electrode block 11, the second electrode block 21, and the dummy electrode 30 are all grid electrodes, the grid lines of the grid electrodes are located in the spaces between the sub-pixels 40. That is, the electrode lines of the grid electrodes avoid each sub-pixel 40, so that the grid electrodes do not affect the light output of each sub-pixel 40.

Optionally, an OLED light-emitting component is included in each sub-pixel. Of course, other types of light-emitting components, such as liquid crystal light emitting components are also suitable for use in the present disclosure.

### Example 3

This embodiment provides a touch display apparatus, including the touch display panel according to one embodiment of the present disclosure.

Specifically, the touch display apparatus can be any product or component having touch display function such as a liquid crystal touch display module, an organic light emitting diode (OLED) touch display module, a mobile phone, a tablet computer, a television, a display, a notebook computer, a digital photo frame, a navigation device, and the like.

### Example 4

The embodiment provides a method for manufacturing a touch substrate. The method for manufacturing the touch substrate includes forming a plurality of first electrode blocks, a plurality of second electrodes, and a plurality of dummy electrodes disposed in the same layer and forming a bridge. The plurality of first electrode blocks distributed along the first direction form a first electrode, and the second electrode extends in a direction crossing the first direction. The second electrode includes a plurality of connected second electrode blocks. Every adjacent first electrode blocks of each of the first electrodes is separated by the second electrode blocks. The bridge connects adjacent first electrode blocks of the same first electrode. The first electrode block and the adjacent second electrode block have opposite sides, and the dummy electrode is disposed between opposite sides of the first electrode block and the adjacent second electrode block. A plurality of dummy electrodes that do not electrically connected to one another are disposed between at least one pair of opposite sides of the first electrode block and the adjacent second electrode.

Optionally, the bridge may be “above” the layer where the second electrode is located, that is, the side of the layer where the second electrode is located opposite from the base substrate of the touch substrate. Optionally, the bridge may be “below” the layer where the second electrode is located, that is, the side of the layer where the second electrode is located facing the base substrate of the touch substrate. The following is a specific process for manufacturing the aforementioned touch substrate according to one embodiment of the present disclosure. The process corresponds to a form in which the display substrate and the touch substrate are integrated. First, a display substrate is fabricated, and then a touch structure is formed on the display substrate. As such, the substrate includes the display substrate as well as the touch substrate. The process may include steps 51-56 below.

Step 51 includes forming an insulating layer such as a silicon dioxide layer on a thin film encapsulation layer of a display substrate.

Step 52 includes coating a layer of metal material on the insulating layer.

Step 53 includes etching the layer of the metal material layer to form the metal bridge.

Step 54 includes coating a second insulating layer and etching the second insulating layer to form via holes connecting with the above metal bridges.

Step 55 includes forming a second layer of metal material on the second insulating layer and patterning the second layer of metal material to form the first electrode blocks, the second electrodes and the dummy electrodes. The structures of the first electrode blocks, the second electrodes and the dummy electrodes satisfy the requirements according to one embodiment of the present disclosure.

Step 56 includes forming a protective layer on the second layer of metal material.

Other embodiments of the present disclosure will be apparent to the skilled in the art from consideration of the specification and the disclosure herein. The present application is intended to cover any variations, uses, or adaptations of the present disclosure, which are in accordance with the general principles of the disclosure and include common general knowledge or common technical means in the art that are not disclosed in the present disclosure. The specification and examples of the present disclosure are to be regarded as illustrative only, and the scope and spirit of the disclosure is pointed out by the appended claims.

1. A touch substrate, comprising:
a plurality of first electrodes extending in a first direction, each of the plurality of first electrodes comprising a plurality of first electrode blocks,
a plurality of second electrodes extending in a second direction, each of the plurality of second electrodes comprising a plurality of second electrode blocks, the second direction crossing the first direction, and
a plurality of dummy electrodes spaced apart from one another between opposite sides of at least one pair of a first electrode block and an adjacent second electrode block.

2. The touch substrate of claim 1, wherein the first electrode blocks, the second electrode blocks, and the dummy electrodes are disposed in a same layer.

3. The touch substrate of claim 1, wherein adjacent first electrode blocks of a same first electrode are connected by a bridge insulated from the second electrodes.

4. The touch substrate of claim 3, wherein the bridge is above or below a layer where the plurality of second electrodes is located.

5. The touch substrate of claim 1, wherein every adjacent first electrode blocks of each of the first electrodes is separated by the second electrode blocks.

6. The touch substrate of claim 1, wherein the plurality of dummy electrodes that are not electrically connected to one another are distributed in a direction perpendicular to the opposite sides of at least one pair of the first electrode block and the adjacent second electrode block.

7. The touch substrate of claim 1, wherein the plurality of dummy electrodes that are not electrically connected to one another are distributed in a direction parallel to the opposite sides of at least one pair of the first electrode block and the adjacent second electrode block.

8. The touch substrate of claim 1, wherein the plurality of dummy electrodes that are not electrically connected to one another has the same shape and size.

9. The touch substrate of claim 1, wherein the first electrode blocks, the second electrode blocks, and the dummy electrodes are all grid electrodes.

10. The touch substrate of claim 9, wherein each of the grid electrodes comprises a plurality of grid lines, and the plurality of grid lines forms a plurality of hexagons or a plurality of parallelograms.

11. The touch substrate according to claim 1, wherein the plurality of second electrode blocks is directly connected.

12. The touch substrate according to claim 1, wherein one of the plurality of first electrodes and the plurality of second electrodes is touch sensing electrodes and the other one of the plurality of first electrodes and the plurality of second electrodes is touch driving electrodes.

13. A touch display panel, comprising:
the touch substrate according to claim 1; and
a plurality of sub-pixels.

14. The touch display panel of claim 13, further comprising a display substrate, the plurality of sub-pixels being disposed on the display substrate,
wherein the touch substrate is disposed on a light-emitting side of the display substrate.

15. The touch display panel of claim 13, wherein the first electrode blocks, the second electrode blocks, and the dummy electrodes are all grid electrodes comprising a plurality of grid lines; and the plurality of grid lines are located in spaces among the plurality of sub-pixels.

16. The touch display panel of claim 13, wherein each of the plurality of sub-pixels comprises an OLED light emitting component.

17. A touch display apparatus, comprising the touch display panel according to claim 13.

18. A method of forming a touch substrate, comprising:
forming a plurality of first electrodes extending in a first direction, each of the plurality of first electrodes comprising a plurality of first electrode blocks; a plurality of second electrodes extending in a second direction, each of the plurality of second electrodes comprising a plurality of second electrode blocks; a plurality of dummy electrodes that are spaced apart from one another between opposite sides of at least one pair of a first electrode block and an adjacent second electrode block.

19. The method of claim 18, wherein the first electrode blocks, the second electrode blocks, and the dummy electrode are disposed in a same layer.

20. The method of claim 18, further comprising forming a plurality of bridges, wherein each of the plurality of bridges connects adjacent first electrode blocks of a same first electrode, and the plurality of bridges is above or below the layer where the plurality of second electrodes is located.
